(19) United States
(12) Patent Application Publication
(10) Pub. No.: US 2004/0127386 A1
(43) Pub. Date: Jul. 1, 2004

(54) Granular component for use in particulate detergent compositions

(75) Inventors: Daniel de Lima Goncalves, Sao Paulo (BR); Andreas Theodorus Groot, Vlaardingen (NL); Marco Klaver, Vlaardingen (NL); Cornelis Paulus Montanus, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/727,228

(22) Filed: Dec. 3, 2003

(30) Foreign Application Priority Data
Dec. 5, 2002 (GB) 0228357.0

(51) Int. Cl. C11D 17/00

(52) U.S. Cl. 510/444; 510/445

(57) ABSTRACT

A granular component for use in a particulate detergent composition, the granules of which comprise an active substance and comprise an incomplete coating wherein less than 70% of the surface area of the component is coated. Preferably the granules are partially coated in a water-soluble partially hydrophobic coating.

### TECHNICAL FIELD

The present invention relates to a granular component which comprises an active substance which is for use as an additive to a conventional detergent composition.

### BACKGROUND AND PRIOR ART

Modern detergent compositions contain a diverse number of ingredients with a wide range of technical requirements, both from a washing function and a product structuring point of view. Frequently the formulator is faced with a compromise between those ingredients which provide a technical benefit in aqueous solution and those which satisfy stringent physical requirements. For example a particulate laundry detergent composition may comprise ingredients which are liquid at room temperature, however they will be limited in concentration due to the requirement of flowability. Another significant problem which the formulator faces is how to incorporate active substances which provide a technical benefit in the wash but can provide a negative effect if present in a locally high concentration on the fabrics to be treated. Such ingredients are for example, enzymes, bleach ingredients (e.g photobleaches), dyes and fluorescers. Such active ingredients should be delivered to the wash such that there are no local high concentrations on the fabrics to be treated. However, often, such active substances need to, or are preferably, present in the particulate detergent composition in locally high concentration due to other physical constraints such as a reactive tendency with other ingredients or because they deactivate due to absorbed moisture unless present as separate coated granules. One possible technical solution to this problem is to enable the granules which contain the active ingredients to float on the surface of the wash liquor, thereby releasing their active ingredient into the wash liquor in a controlled manner without locally high concentrations.

U.S. Pat. No. 4,762,636 (Ciba-Geigy) discloses a process for making granules which comprise an active substance and rely on their natural low density to enable them to float on the surface of the wash liquor.

DE 3 430 773A (Ciba-Geigy) discloses a washing powder additive in speckle form which contains a photobleach, an inorganic carbonate and an acid. Effervescence action generated by the reaction between the carbonate and the acid is claimed to keep the speckles at the surface of the wash liquor and reduce staining of the washed fabrics.

EP 273 775 (Albright & Wilson) discloses a protected additive which comprises an active agent for use in liquid detergent compositions which has an outer coating which is both hydrophobic and water-insoluble (e.g. silicone oil or hydrocarbon polymer).

EP 297 373 (Colgate) discloses a bleaching granule for use in particulate detergent compositions which is at least partially coated in a fatty acid material.

However, it was found that the above teachings each have a disadvantage when incorporating them into particulate detergent compositions. In particular, previous coating processes aim to give as complete coverage as possible.

The present inventors have surprisingly discovered that active ingredients for use in particulate detergent compositions may be delivered to a wash liquor more effectively than previously if they are resent in a granule which has an incomplete coating of hydrophobic material. Such granules have the quality of having protection from other detergent ingredients but also allow controlled release of the active ingredients into the wash liquor.

### DEFINITION OF THE INVENTION

In a first aspect, the present invention provides a granular component for use in a particulate detergent composition, the granules of which comprise an active substance and comprise an incomplete coating wherein less than 70% of the surface area of the component is coated.

In a second aspect, the present invention provides a particulate detergent composition which comprises from 0.1 to 5 wt % of a granular composition as defined above.

In a third aspect, the present invention provides a process for making a granular component for use in a particulate detergent composition, which comprises the step of adding a liquid coating material to a precursor granular material, the precursor granular material comprising an active substance, wherein the precursor granular material is maintained at a temperature below the melting point of the liquid coating material as the liquid coating material is added, the coating material thereby solidifying on the surface of the precursor granular material and the coating material being added in such a quantity that there is an incomplete coating on the surface of the precursor granular material wherein less than 70% of the surface area of the component is coated.

### DETAILED DESCRIPTION OF THE INVENTION

I. The Granular Component

The present invention relates to a granular component comprising a relatively high concentration of active substance which is/are intended to be added as a minor component to a particulate laundry detergent composition and a process for making the granular composition. In a preferred embodiment, the granular composition also provides the function of a coloured speckle in the detergent powder.

Preferably the granular composition has a d₅₀ average particle size of from 100 to 1000 micrometres, preferably 200 to 600 micrometres.

The Coating

The coating of the present invention is characterised in that it is an incomplete coating. It is believed that this technical feature provides an improved delivery vehicle for active substances in particulate detergent compositions. Without wishing to be bound by theory it is believed that the incomplete coating is sufficient to provide effective release properties but also allows wash liquor to penetrate the granule and release the active substance contained within in a controlled manner.

It is preferred that the coating has a degree of hydrophobicity as this enables the granule to have a preference for floating on the surface of a wash liquor. The degree of hydrophobicity may be measured by the contact angle which a flat sample of the coating makes with distilled water at 25° C. It is preferred that the coating thus has a contact angle of from 10° to 180°, preferably from 30° to 150°, more preferably from 45° to 90°.

It is preferred that the coating is present as discrete domains, such that the exterior of the granule consists of regions which are coated and regions which are uncoated. Preferably the average equivalent diameter of the area covered by such domains will be from 10 to 100 micrometres.

It is important that the coating is not so complete as to inhibit the ingress of water when the granule is used. Therefore less than 70%, more preferably less than 50%, of the surface area of the component is coated. Preferably the amount of coating is greater than 10%, more preferably grater than 20%. Therefore one preferred range is from 10 to 70%.

Preferably the coating is a water-soluble material or is soluble in an aqueous alkaline solution, or both. Suitable materials are C₈ to C₂₀ fatty acids.

Preferably the granular composition comprises from 1 to 10 wt %, preferably from 2 to 5 wt %, of the coating.

Preferably the coating of the present invention satisfies two conflicting requirements. Firstly the tendency to be hydrophobic in contact with water, i.e. has a contact angle with water of greater than 300, preferably greater than 60°. Secondly, to be soluble in water in order that the coating does not persist as an insoluble component on the surface of the wash liquor.

Due to the conflicting requirements of solubility and hydrophobicity, suitable materials may need to compromise on either one or both of these requirements, hence a material which has a contact angle with water of less than 1200, or even less than 90°, may be sufficiently hydrophobic.

The Active Substance

The active substance may be a material selected from bleach ingredients, enzymes, dyes, fluorescers. The invention is especially useful for the incorporation of photobleach ingredients which have a tendency to provide localised staining on washed fabrics. Preferred photobleaches are phthalocyanine sulphonates, especially zinc phthalocyanine sulphonates, aluminium phthalocyanine sulphonates or a mixture of the two.

The Carrier Particles

When the active substance is present in liquid form, or in any case, it may be desirable for the granular composition of the present invention to comprise at least one water-soluble or water-dispersible solid carrier particle.

Preferably the carrier particles are selected from sodium carbonate, sodium tripolyphosphate, zeolites or a mixture thereof.

The Optional Binder

To aid the structure of the granular component it may further comprise a binder. The binder is preferably a hydrophilic binder. The binder is especially useful when the granules comprise a plurality of water-soluble carrier particles.

Preferred binders are the polyethylene glycols. Even more preferred are the polyethylene glycols with a molecular weight of from 2000 to 10000.

Hence a particularly preferred embodiment is wherein a majority of the granules comprise a plurality of water-soluble or water-dispersible carrier particles bound together with a hydrophilic binder and are incompletely coated in a hydrophobic material.

The Detergent Composition

As already described, the granular composition of the present invention is intended to be used in a particulate detergent composition. Preferably such compositions comprise from 0.1 to 5 wt %, preferably from 0.5 to 2 wt %, of the granular composition of the present invention.

The particulate detergent composition comprises from 5 to 60 wt % of surfactant, from 10 to 80 wt % of detergency builder and optionally other detergent ingredients.

The base powder(s) of the detergent composition may be manufactured by any suitable process. For example, they may be produced by spray-drying, spray-drying followed by densification in a batch or continuous high speed mixer/densifier or by a wholly non-tower route comprising granulation of components in a mixer/densifier, preferably in a low shear mixer/densifier such as a pan granulator or fluidised bed mixer.

Separately produced granular components, such as the granular component of the present invention, may be dry-mixed with the detergent composition in any suitable apparatus. The detergent compositions of the present invention may include additional powdered components dry-mixed with the granular component.

Suitable components which may be post-dosed to the granular components or included in the base powder(s) will be discussed further below.

Other Detergent Ingredients

Detergent-active compounds (surfactants) may be chosen from soap and non-soap anionic, cationic, nonionic, amphoteric and zwitterionic detergent-active compounds, and mixtures thereof. Many suitable detergent-active compounds are available and are fully described in the literature, for example, in “Surface-Active Agents and Detergents”, Volumes I and II, by Schwartz, Perry and Berch. The preferred detergent-active compounds that can be used are soaps and synthetic non-soap anionic and nonionic compounds. The total amount of surfactant present is suitably within the range of from 5 to 40 wt %.

Anionic surfactants are well-known to those skilled in the art. Examples include alkylbenzene sulphonates, particularly linear alkylbenzene sulphonates having an alkyl chain length of C₈-C₁₅; primary and secondary alkylsulphates, particularly C₈-C₁₅ primary alkyl sulphates; alkyl ether sulphates; olefin sulphonates; alkyl xylene sulphonates; dialkyl sulphosuccinates; and fatty acid ester sulphonates. Sodium salts are generally preferred.

Nonionic surfactants that may be used include the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkylpolyglycosides, glycerol monoethers, and polyhydroxyamides (glucamide).

Cationic surfactants that may be used include quaternary ammonium salts of the general formula R₁R₂R₃R₄N⁺ X⁻ wherein the R groups are long or short hydrocarbyl chains, typically alkyl, hydroxyalkyl or ethoxylated alkyl groups, and X is a solubilising cation (for example, compounds in which R₁ is a C₈-C₂₂ alkyl group, preferably a C₈-C₁₀ or C₁₂-C₁₄ alkyl group, R₂ is a methyl group, and R₃ and R₄, which may be the same or different, are methyl or hydroxyethyl groups); and cationic esters (for example, choline esters).

Detergent compositions suitable for use in most automatic fabric washing machines generally contain anionic non-soap surfactant, or nonionic surfactant, or combinations of the two in any ratio, optionally together with cationic, amphoteric or zwitterionic surfactants, optionally together with soap.

The detergent compositions of the invention also contain one or more detergency builders. The total amount of detergency builder in the compositions will suitably range from 5 to 80 wt %, preferably from 10 to 60 wt %.

The zeolite builders may suitably be present in a total amount of from 5 to 60 wt %, preferably from 10 to 50 wt %. Amounts of from 10 to 45 wt % are especially suitable for particulate (machine) laundry detergent compositions.

The zeolites may be supplemented by other inorganic builders, for example, amorphous aluminosilicates, or layered silicates such as SKS-6 ex Clariant. Sodium carbonate, already listed as a possible ingredient, may also act in part as a builder.

Examples of phosphorous-containing inorganic detergency builders include the water-soluble salts, especially the alkali metal salts of pyrophosphates, orthophosphates, polyphosphates and phosphonates.

If present, the phosphorus containing inorganic builder is preferably pyrophosphate or polyphosphate. Specific examples of inorganic phosphate builders include sodium and potassium tripolyphosphates, orthophosphates and hexametaphosphates.

The zeolites may be supplemented by organic builders, for example, polycarboxylate polymers such as polyacrylates and acrylic/maleic copolymers; monomeric polycarboxylates such as citrates, gluconates, oxydisuccinates, glycerol mono-, di- and trisuccinates, carboxymethyloxysuccinates, carboxymethyloxymalonates, dipicolinates, hydroxyethyliminodiacetates, alkyl- and alkenylmalonates and succinates; and sulphonated fatty acid salts.

These lists of builders are not intended to be exhaustive.

Especially preferred organic builders are citrates, suitably used in amounts of from 5 to 30 wt %, preferably from 10 to 25 wt %; and acrylic polymers, more especially acrylic/maleic copolymers, suitably used in amounts of from 0.5 to 15 wt %, preferably from 1 to 10 wt %. Builders, both inorganic and organic, are preferably present in alkali metal salt, especially sodium salt, form.

Detergent compositions according to the invention may also suitably contain a bleach system. It is preferred that the compositions of the invention contain peroxy bleach compounds capable of yielding hydrogen peroxide in aqueous solution, for example inorganic or organic peroxyacids, and inorganic persalts such as the alkali metal perborates, percarbonates, perphosphates, persilicates and persulphates. Bleach ingredients are generally post-dosed as powders.

The peroxy bleach compound, for example sodium percarbonate, is suitably present in an amount of from 3 to 30 wt %, preferably from 5 to 20 wt %.

The peroxy bleach compound, for example sodium percarbonate, may be used in conjunction with a bleach activator (bleach precursor) to improve bleaching action at low wash temperatures. The bleach precursor is suitably present in an amount of from 0.5 to 6 wt %, preferably from 1 to 4 wt %.

Preferred bleach precursors are peroxycarboxylic acid precursors, more especially peracetic acid precursors and peroxybenzoic acid precursors; and peroxycarbonic acid precursors. An especially preferred bleach precursor suitable for use in the present invention is N,N,N′,N′-tetracetyl ethylenediamine (TAED).

A bleach stabiliser (heavy metal sequestrant) may also be present. Suitable bleach stabilisers include ethylenediamine tetraacetate (EDTA) and the polyphos-phonates such as Dequest (Trade Mark), EDTMP. A bleach catalyst may also be included.

The detergent compositions of the invention may also contain alkali metal, preferably sodium, carbonate, in order to increase detergency and ease processing. Sodium carbonate may suitably be present in amounts ranging from 1 to 60 wt %, preferably from 2 to 40 wt %. However, compositions containing little or no sodium carbonate are also within the scope of the invention. Sodium carbonate may be included in granular components, or post-dosed, or both.

The detergent composition may contain water-soluble alkali metal silicate, preferably sodium silicate having a SiO₂:Na₂O mole ratio within the range of from 1.6:1 to 4:1. The water-soluble silicate may be present in an amount of from 1 to 20 wt %, preferably 3 to 15 wt % and more preferably 5 to 10 wt %, based on the aluminosilicate (anhydrous basis).

Powder flow may be improved by the incorporation in one or both granular components of a small amount of a powder structurant. Examples of powder structurants, some of which may play other roles in the formulation as previously indicated, include, for example, fatty acids (or fatty acid soaps), sugars, acrylate or acrylate/maleate polymers, sodium silicate, and dicarboxylic acids (for example, Sokalan (Trade Mark) DCS ex BASF). One preferred powder structurant is fatty acid soap, suitably present in an amount of from 1 to 5 wt %.

Other materials that may be present in detergent compositions of the invention include antiredeposition agents such as cellulosic polymers; soil release agents; anti-dye-transfer agents; fluorescers; inorganic salts such as sodium sulphate; enzymes (proteases, lipases, amylases, cellulases); dyes; coloured speckles; perfumes; and fabric conditioning compounds. These may be included in one or both granular components, if sufficiently robust, or alternatively postdosed in granular form, as is well known to those skilled in the art. This list is not intended to be exhaustive.

II. The Process for Making the Granules

The process for making the granules of the present invention involves the important step which comprises the step of adding a liquid hydrophobic material to a precursor granular material. The precursor granular material will become a granule of the present invention after receiving its incomplete coating of hydrophobic material and it therefore comprises an active substance. In the process, the precursor granular material is maintained at a temperature below the melting point of the liquid hydrophobic material as the liquid hydrophobic material is added, the hydrophobic material thereby solidifying on the surface of the precursor granular material. Furthermore the hydrophobic binder is added in a relatively low amount. This technical feature of the process, in combination with the solidification of the hydrophobic coating ensures that there is an incomplete coating on the surface of the precursor granular material.

It is preferred that the hydrophobic material is sprayed onto the precursor granular material. If sprayed on then it is preferred that the spray-on rate is from 15 to 50 g/minute per kg of precursor granular material.

Preparation of the Precursor Granular Material

The precursor granular material is a solid particulate material which comprises an active substance.

The precursor granular material will generally comprise a solid carrier material and a liquid active material carried thereon. However it is also possible that the precursor granular material may comprise a solid active material which does not need a solid carrier. The present invention relates mainly to the former case where a carrier material is required to carry the liquid active substance.

If the active substance is in liquid form and it is carried on solid carrier particles then these particles will be water-soluble or water-dispersible. When the carrier particles are present, each granule of the present invention will comprise at least one carrier particle. It is preferred that the active substance is sprayed onto the water-soluble or water-dispersible carrier particles. When sprayed on it is preferred that the spray-on rate is from 10 to 20 g/minute per kg of carrier particles.

When it is intended that each granule of the present invention comprises a plurality of carrier particles then it is preferred that they are bound together, either before or after the active substance is added, with a hydrophilic binder. It is preferred that the hydrophilic binder is sprayed onto the carrier particles, and preferably the spray-on rate is from 30 to 100 g/minute per kg of carrier particles. In order to assist the granulation of the carrier particles it is preferred that the carrier particles are maintained at a temperature below the melting point of the liquid hydrophilic binder as the liquid hydrophilic binder is added, the hydrophilic binder thereby solidifying on the surface of the carrier particles.

Equipment

The granules of the present invention may be made in any apparatus suitable for adding liquids to particulate solids, such as mechanical mixers or fluidised beds. It is preferred that at least one liquid addition step (e.g. addition of the active substance (if liquid), the hydrophilic binder (if required) or the hydrophobic material) is carried out in a fluidised bed. Preferably all the liquid addition steps of the process are carried out in a fluidised bed. Fluidised beds are particularly suitable for the process of the present invention since the temperature of the particulate materials may be accurately controlled by controlling the temperature of the fluidising gas.

### EXAMPLES

### Examples 1 to 6 and Comparative Examples A to D

Photobleach Granular Compositions

Light soda ash, sodium tripolyphosphate (STPP) or a mixture thereof was fluidised in a fluidised bed and a 10% active photobleach solution was sprayed on. The photobleach solution was sprayed onto the moving particles at a rate of 15 g/minute per kg of carrier. The carrier particles did not granulate together and merely absorbed the active photobleach solution.

This initial stage was followed by the addition of a polyethylene glycol (PEG) binder. The PEG had a molecular weight of 1500. The PEG was heated in order to reduce its viscosity and aid the spray-on process. The PEG was sprayed onto the carrier particles at a rate of 50 g/minute per kg of carrier particles. The fluidised bed was maintained at a bed temperature of 20° C. so that the PEG solidified once in contact with the carrier particles. The PEG binder had the effect of binding together the carrier particles so that the particle size of the fluidised particles increased.

This stage was then followed by the addition of the coating material which in this case is a carboxylic fatty acid with a chain length of 12-16 carbon atoms or a propylene glycol with a molecular weight of 4000 or a mixture thereof. The fatty acid was heated in order to reduce its viscosity and aid the spray-on process. The fatty acid was sprayed onto the carrier particles at a rate of 30 g/minute per kg of carrier particles. The fluidised bed was maintained at a bed temperature of 20° C. so that the fatty acid solidified upon contact with the precursor granule material. The fatty acid was sprayed onto the bed to ensure that the majority of the particles had an incomplete coating.

Two Comparative Examples (C and D) were made using water as a binder instead of PEG and an acrylic/maleic copolymer (Sokalan CP5 available from BASF) as a coating.

Staining Tests

Six pieces of white knitted cotton of size 15 cm×15 cm were used as test cloths. The cloths were placed at the bottom of a bowl containing 1 litre of water, onto which 10 g of the detergent composition was poured. The detergent composition was allowed to settle for 10 minutes, after which the fabric was removed and gently rinsed to remove any detergent residues. The fabrics were subsequently dried in a tumble drier and then assessed for the degree of staining, by an expert panel, on a scale of 1 to 5. A result of 1 means no staining and a result of 5 means full staining. A summary of the experimental conditions and the staining results are shown in table 3.

The above process was carried out for different types of carrier particles and gave granular compositions having the following compositions:

TABLE 1

| Ingredient | A | 1 | 2 | 3 | B | 4 | 5 | 6 | C | D |
|---|---|---|---|---|---|---|---|---|---|---|
| Photobleach | 1.25 | 1.25 | 1.25 | 1.25 | 1.25 | 1.25 | 1.25 | 1.25 | 1.25 | 1.25 |
| solution | | | | | | | | | | |
| Sodium | 74.1 | 73.3 | 70.3 | 66.6 | 70.3 | 69.6 | 35.9 | 71.8 | — | — |
| carbonate | | | | | | | | | | |
| STPP | — | — | — | — | — | — | 35.9 | — | 56.4 | 54.7 |
| PEG 1500 | 24.7 | 24.4 | 23.4 | 22.2 | 23.4 | 23.2 | 23.9 | 23.9 | — | — |
| Fatty acid | — | 1.03 | 4.99 | 9.99 | — | 1.01 | 3.05 | 3.05 | — | 3.01 |
| PPG | — | — | — | — | 5.01 | 5.01 | — | — | — | — |
| CP5 | — | — | — | — | — | — | — | — | 10.6 | 10.3 |
| Water | — | — | — | — | — | — | — | — | 31.7 | 30.8 |
| Staining | 3-4 | 2 | 1 | 1 | 2 | 2 | 1 | 1 | 3-4 | 2-3 |

### Examples 3 and 4

### Detergent Compositions

The formulations shown in the following table represent detergent compositions in accordance with the invention.

| | wt % | | | |
|---|---|---|---|---|
| Ingredient | 3 | 4 | 5 | 6 |
| Spray Dried Base | | | | |
| C₁₂-C₁₈ Sodium LAS | 17.73 | 6.59 | 19.5 | 12.3 |
| Nonionic surfactant(C₁₂₋₁₃ 6-7 EO) | — | 3.27 | — | 2.9 |
| Sodium soap | 0.78 | 2.39 | — | — |
| Sodium tripolyphosphate | 21.4 | 24.1 | 31.7 | 34.4 |
| Sodium silicate | 7.34 | 6.79 | 5.63 | 6.58 |
| Sodium carboxymethylcellulose | 0.33 | 0.49 | 0.20 | 0.47 |
| Fluorescer | 0.10 | 0.13 | 0.11 | 0.14 |
| Sodium sulphate | 22.6 | 25.8 | 12.3 | 0.61 |
| Sodium chloride | — | — | — | 1.83 |
| Silicone antifoam | — | — | 0.03 | 0.05 |
| Water | 12.8 | 9.8 | 12.1 | 16.0 |
| Post Dosed | | | | |
| Sodium carbonate | 14.2 | 16.7 | 12.7 | 15.33 |
| Enzymes | 0.45 | 0.58 | 0.24 | 0.68 |
| Perfume | 0.28 | 0.33 | 0.27 | 0.31 |
| Antifoam granule | — | 1.0 | — | 3.0 |
| Sodium perborate | — | — | 2.38 | 2.5 |
| TAED | — | — | 0.86 | 0.90 |
| Photobleach granules of Example 1 | 2.00 | 2.00 | 2.00 | 2.00 |

We claim:

1. A granular component for use in a particulate detergent composition, the granules of which comprise an active substance and wherein it comprises an incomplete coating wherein less than 70% of the surface area of the component is coated.

2. A granular component as claimed in claim 1, wherein from 10 to 70% of the surface area of the component is coated.

3. A granular component as claimed in claim 1, wherein the coating is a material which has a contact angle with distilled water at 25° C. of from 10° to 180°.

4. A granular component as claimed in claim 1, wherein the coating material is present in the form of discrete domains.

5. A granular component as claimed in claim 4, wherein the average diameter of the coverage of the domains is from 10 to 100 micrometres.

6. A granular component as claimed in claim 1, wherein the coating is water-soluble.

7. A granular component as claimed in claim 1, wherein the coating is soluble in an alkaline aqueous solution.

8. A granular component as claimed in claim 1, wherein the coating is a fatty acid.

9. A granular component as claimed in claim 1, wherein it has a d₅₀ average particle size of from 100 to 1000 micrometres.

10. A granular component as claimed in claim 9, wherein it has a d₅₀ average particle size of from 200 to 600 micrometres.

11. A granular component as claimed in claim 1, wherein it is a coloured speckle component.

12. A granular component as claimed in claim 1, wherein the active substance is a photobleach, preferably a zinc and/or aluminium phthalocyanine sulphonate.

13. A granular component as claimed in claim 1, wherein the granules comprise at least one water-soluble or water-dispersible solid carrier particle.

14. A granular component as claimed in claim 13, wherein the carrier particles are selected from sodium carbonate, sodium tripolyphosphate, zeolites or a mixture thereof.

15. A granular component as claimed in claim 1, wherein the granules comprise a hydrophilic binder.

16. A granular component as claimed in claim 13, wherein a majority of the granules comprise a plurality of water-soluble or water-dispersible carrier particles bound together with a hydrophilic binder.

17. A particulate detergent composition wherein it comprises from 0.1 to 5 wt %, preferably from 0.5 to 2 wt %, of a granular component as claimed in any preceding claim.

18. A process for making a granular component for use in a particulate detergent composition, wherein it comprises the step of adding a liquid coating material to a precursor granular material, the precursor granular material comprising an active substance, wherein the precursor granular material is maintained at a temperature below the melting point of the liquid coating material as the liquid coating material is added, the coating material thereby solidifying on the surface of the precursor granular material and the coating material being added in such a quantity that there is an incomplete coating on the surface of the precursor granular material wherein less than 70% of the surface area of the component is coated.

19. A process as claimed in claim 18, wherein the liquid coating material is sprayed onto the precursor granular material.

20. A process as claimed in claim 18, wherein it is preceded by two stages wherein, in the first stage, an active substance is added to water-soluble or water-dispersible carrier particles and then, in the second stage, a liquid binder is added to form the precursor granular material.

21. A process as claimed in claim 20, wherein the active substance is sprayed onto the water-soluble or water-dispersible carrier particles.

22. A process as claimed in claims 20, wherein the liquid binder is sprayed onto the water-soluble or water-dispersible carrier particles.

23. A process as claimed in claim 20, wherein the water-soluble or water-dispersible carrier particles are maintained at a temperature below the melting point of the liquid binder as the liquid hydrophilic binder is added, the binder thereby solidifying on the surface of the carrier particles.

24. A process as claimed in claim 20, wherein a majority of the water-soluble or water-dispersible carrier particles granulate as the liquid hydrophilic binder is added.

25. A process as claimed in claim 19, wherein at least one of the liquid addition stages is carried out in a fluidised bed.

26. A process as claimed in claim 25, wherein all of the liquid addition stages are carried out in a fluidised bed.
